(19) United States
(12) Patent Application Publication
(10) Pub. No.: US 2006/0252290 A1
(43) Pub. Date: Nov. 9, 2006

(54) Female electrical receptacle

(76) Inventors: Curtis Jungwirth, Newberg, OR (US); Troy Jungwirth, Dundee, OR (US)

Correspondence Address: IPSOLON LLP, 111 SW COLUMBIA, SUITE 710, PORTLAND, OR, 97201, US

(21) Appl. No.: 11/120,613

(22) Filed: May 3, 2005

(51) Int. Cl. H01R 13/648

(52) U.S. Cl. 439/106

(57) ABSTRACT

A female service outlet for is configured for receiving a male electrical plug and is defined by an outer body section, an inner body section, and a shoulder therebetween. The receptacle may be pre-wired and the inner body section is configured to extend into an opening formed in a wall and the shoulder has a dimension greater than the inner body section. Fasteners hold the receptacle in place against the wall.

### TECHNICAL FIELD

This invention relates to electrical receptacles, and more specifically to a female electrical receptacle and service outlet that may be installed easily in convenient locations such as service panels, junction boxes, distribution panels and the like.

### BACKGROUND OF THE INVENTION

There are many, many types of female electrical receptacles and service outlets. These range from standard 110 volt three-wire household receptacles to specialty receptacles for a variety of other voltage/amperage/phasing combinations. Typically, electrical wire of an appropriate gauge is routed from a circuit breaker in a service panel to a desired location where the receptacle will be positioned. The actual receptacle—that is, the electrical outlet into which a male plug is inserted—is mounted in some type of box, such as a receptacle box that is often permanently mounted, and the wire is connected to the appropriate terminals on the receptacle. Electrical equipment may then be plugged into the female receptacle. There are many types of receptacle boxes that actually hold the female receptacle, including boxes that attach to studs, etc.

Although there are many variations in the manner in which female receptacles are mounted, there is relatively little flexibility in locating a female receptacle because the receptacle must be mounted in a separate box, which in turn is typically mounted to some other structure such as a stud. Sometimes female receptacles are mounted to the end of a long electrical cord, such as an extension cord, but even then the female receptacle itself is still mounted in a box similar to a junction box connected to the end of the extension cord.

There is a need therefore for innovations in the manner in which female electrical receptacles are designed.

The present invention provides a female electrical receptacle and service outlet that mounts easily through an opening formed in any desired location, for example, a service panel, distribution panel, and the like. The receptacle may be molded in a single piece and has an outer section with a larger diameter than an adjacent base section, which typically is threaded. The threaded base section is inserted through an opening in a desired location and a nut is threaded onto the base section to hold the receptacle in place. In one preferred embodiment, the receptacle is pre-wired with the appropriate number of electrical conductors such as wire of an appropriate gauge. Once the female receptacle is mounted in the desired location, the wiring is connected to the source wiring, which in turn is connected to the power source such as a circuit breaker in a service panel.

In yet another preferred embodiment, the receptacle includes an optional rain cover.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a perspective and exploded view of a female receptacle according to the present invention shown partially assembled in conjunction with an opening in a junction box such as a service panel, which is shown schematically.

FIG. 2 is a perspective view of an exemplary box with two female receptacles according to the present invention located therein.

FIG. 3 is a side partial sectional view of the female receptacle shown in FIG. 1 with an optional rain cover, taken along the line 3-3 of FIG. 2, and illustrating the receptacle mounted in a service panel.

FIG. 4 is a perspective and exploded view of a first illustrated alternative embodiment of a female receptacle according to the present invention.

### DETAILED DESCRIPTION OF ILLUSTRATED EMBODIMENTS

With reference to the figures, a female receptacle 10, which is also referred to at times herein as a service outlet, is illustrated as comprising a typical configuration for a 110 or 125 volt installation that includes three insulated wiring conductors, namely hot 12, neutral 14 and ground 16. The three wiring conductors are arranged in end portion 18 of receptacle 10 with corresponding plug slots 20, 22 and 24, respectively to accept a standard male plug compatible with the female receptacle. It is to be understood that the female receptacle 10 illustrated in the drawings is shown as a standard 110 volt 3-wire model only for the purposes of detailing the features of the invention defined in the claims herein. The invention is not limited to a 110 volt configuration, or to a 3-wire system. Instead, those of ordinary skill in the art will appreciate that the female receptacle defined in the claims may be used with numerous other combinations of plug configurations, voltages, amperages, phasing, etc.

Female receptacle 10 is defined by a main body 26 having an outer section 28, and a base section 30 adjacent the outer section. In the embodiment shown in the figures, both outer section 28 and base section 30 are cylindrical and coaxially oriented, and base section 30 is threaded. The diameter of outer section 28 is greater than the diameter of base section 30 so that there is a shoulder 32 between two body sections.

Each of the three wire conductors 12,14 and 16 are routed into female receptacle 10 through the innermost end 34 of base section 30. As shown in the drawings, end 34 includes a circumferential starter flange that assists with starting a threaded nut onto the threads of the base section. Internally within receptacle 10, the wire conductors are connected to electrical conductor pads (not shown) in the plug slots 20, 22 and 24 in a standard manner so that a male plug inserted into the female receptacle makes appropriate electrical contact. The free ends of wiring conductors 12, 14 and 16 extend from the innermost end 34 of base section 30.

In the illustrated embodiment, female receptacle 10 is preferably formed in a single piece by a molding process such as injection molding. There are numerous polymeric compounds that may be used to form the receptacle. Nonetheless, a receptacle 10 may be formed according to the present invention in multiple components that may be assembled at a job site or preassembled before use. In the most preferred embodiment the female receptacle is assembled with the wiring conductors 12,14 and 16 in place so that the unit is a fully self-contained that is ready to be installed.

As may be seen in the drawings, the illustrated embodiment shown in the figures illustrates a receptacle 10 having a cylindrically configured outer section 28 and coaxially oriented, cylindrically configured base section 30. It will be appreciated that these two sections 28 and 30 may be formed with different geometries, both separately and with respect to one another. As one example, -the outer section 28 may be formed with a square configuration with a base section that is cylindrical, or vice versa. Thus, regardless of the particular geometry that is used for the outer and base sections, there is a shoulder defined between the two sections that serves to abut a wall where the receptacle is mounted. The dimension of the shoulder is greater than the dimension of the inner section of the body, and as detailed below is also greater the dimension of the opening through which the inner section is inserted when the receptacle is mounted to a wall.

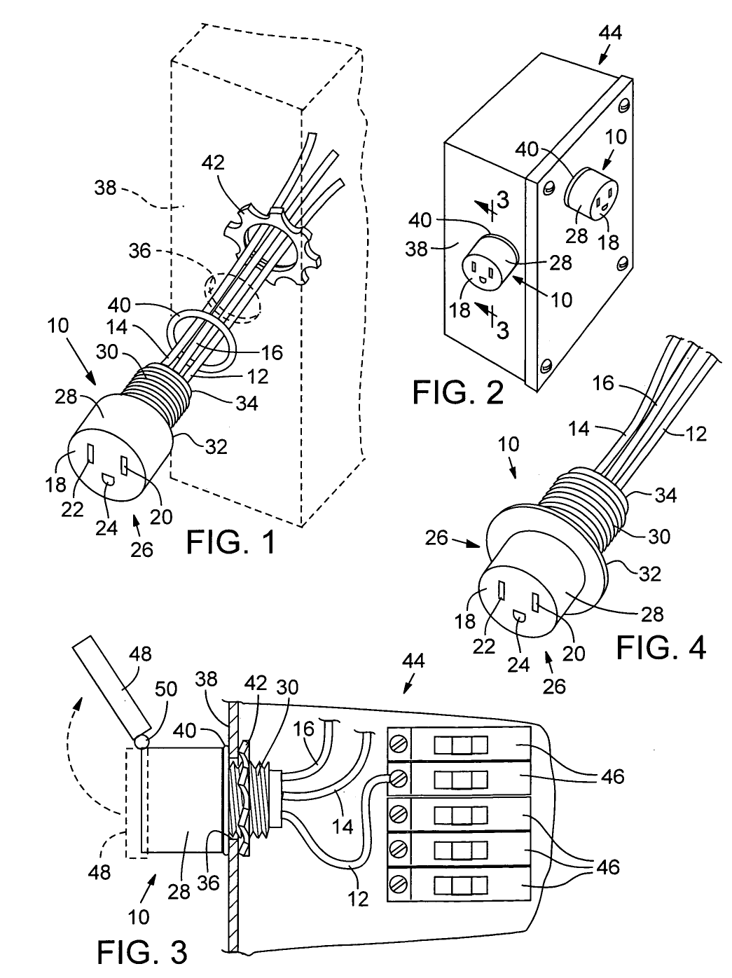

It will readily be appreciated that female receptacle 10 may be mounted in any convenient location without the need for a separate junction box or other receptacle box to hold the receptacle. Thus, with reference once again to FIG. 1, an opening 36 having a diameter configured for receiving base section 30 of receptacle 10 is formed in, for example, a wall 38. The diameter of opening 36 is greater than the diameter of inner section 30 of receptacle 10 so that the inner section may be inserted directly into the opening 36. Receptacle 10 is mounted by inserting the free, unconnected ends of wiring conductors 12, 14 and 16 through opening 36, then inserting base section 30 into opening 36. As shown in FIGS. 1 and 30, a gasket 40 may optionally be placed over base section 30 prior to insertion of the base section into opening 36 to provide a water-tight mounting. The dimension of shoulder 32 is greater than the dimension of opening 36. Receptacle 10 is inserted into opening 36 until shoulder 34 abuts wall 38.

The receptacle is held in place with a fastening mechanism, which in FIG. 1 is shown as a threaded nut 42 that threads onto base section 30. Nut 42 is threaded onto base section 30 until it is tight, thereby securing receptacle 10 in place. Once the receptacle is installed, the free ends of wiring conductors 12,14 and 16 may be connected to appropriate wiring that in turn connects to a hot, neutral and ground source, respectively.

It will be appreciated that other fastening means equivalent to nut 42 and the mating threads on base section 30 may likewise be used to secure the receptacle 10 in place against wall 38. As one example, opening 36 may be threaded and sized so that base 30 threads directly into the opening, thereby eliminating the need for nut 42. Similarly, the outer surface of base 30 may be formed without threads, and a slide-on spring clip may be used in a manner similar to nut 42 to secure the receptacle in place.

With reference now to FIG. 2, it may be seen that two female receptacles 10 are installed in a service panel 44. It will be appreciated that the female receptacle 10 described herein provides a simple service outlet that may be installed with ease in locations where one or more outlets are required or desired, such as service panels, distribution panels, junction boxes, gutters, and numerous other locations.

Turning now to FIG. 3, female receptacle 10 is shown in partial cross section mounted in service panel 44 that includes plural circuit breakers 46. Hot wiring conductor 12 is connected in a standard manner to a circuit breaker 46, and neutral 14 and ground 16 wiring conductors are appropriately connected to neutral and ground, although those connections are not shown. A nut 42 has been threaded onto threaded base section 30 and tightened in place so that shoulder 32 bears on gasket 40 to create a water seal, thereby preventing water from entering the interior of panel 44 through opening 36.

In the embodiment illustrated in FIG. 3, an optional rain cover 48 is attached to outer section 28 of receptacle 10 with a hinge 50. Rain cover 48 is formed such that is has a geometry complementary to the shape of receptacle 10 so that when rain cover 48 is closed, water is effectively prevented from seeping into plug slots 20, 22 and 24. Hinge 50 may be of a spring-loaded type so that rain cover 48 is held in place in the closed position with biasing force, and so that when a male plug is removed from the service outlet, the rain cover springs into the closed position. Typically, the interior portion of rain cover 48—that is, that portion of the rain cover that abuts outer end portion 18 of receptacle 10 when the rain cover is closed, is lined with a foam or other gasket material.

Those of ordinary skill in the art will appreciate that various modifications may be made to the illustrated embodiment to define an equivalent female receptacle. As one example, reference is made to the embodiment shown in FIG. 4. In this embodiment, both outer section 28 and base section 30 have the same configuration, namely, a cylindrical body having the same diameter. A flange member that has a greater diameter than the outer and base sections in this case defines the shoulder 32 between the outer section 28 and base section 30. When the embodiment shown in FIG. 4 is mounted through an opening such as opening 36 shown in FIG. 1, shoulder 32 has a dimension larger than the opening and thus serves to locate the receptacle in place. Thus, it will be appreciated that a female receptacle 10 according to the present invention incorporates a shoulder 32 that has a dimension greater than the dimension of base section 30, and the corresponding opening into which base section 30 is inserted.

Having here described illustrated embodiments of the invention, is anticipated that other modifications may be med thereto the scope of the invention by those of ordinary skill in the art. It will thus be appreciated and understood that the spirit and scope of the invention is not limited to those embodiments, but extend to the various modifications and equivalents as defined in the appended claims.

1. A female electrical receptacle comprising:
a main body having an outer section with an outer end portion configured for receiving a male electrical plug, and an inner section having an outer dimension;
a shoulder between the outer section and the inner section, the shoulder having a dimension greater than the outer dimension of the inner section.

2. The female electrical receptacle according to claim 1 further comprising plural wiring conduits each connected to a respective electrical conductor pad in the outer section and each having a free end extending from the inner section.

3. The female electrical receptacle according to claim 1 wherein the outer section defines a cylindrical body having a first diameter, and the inner section defines a cylindrical body having a second diameter that is less than the first diameter.

4. The female electrical receptacle according to claim 3 wherein the shoulder is defined between the outer section and the inner section.

5. The female electrical receptacle according to claim 4 wherein the outer section is coaxial with the inner section.

6. The female electrical receptacle according to claim 1 wherein the shoulder is defined by a flange between the outer section and the inner section.

7. The female electrical receptacle according to claim 6 wherein the inner section and the outer section define cylinders.

8. The female electrical receptacle according to claim 7 wherein the inner section and the outer section have the same diameter.

9. The female electrical receptacle according to claim 1 wherein the inner section further includes fastening means for mounting the main body to a wall.

10. The female electrical receptacle according to claim 9 wherein the fastening means further comprises threads formed on the inner section.

11. The female electrical receptacle according to claim 10 including a nut for threading onto the threads.

12. The female electrical receptacle according to claim 10 wherein the fastening means further comprises a threaded opening in a wall configured for receiving the threads formed on the inner section.

13. The female electrical receptacle according to claim 9 wherein the fastening means further comprises a spring clip configured for engaging the inner section.

14. A female electrical receptacle comprising:
a main body defined by an outer section with an outer end portion configured for receiving a male electrical plug and an inner section having an outer dimension;
a shoulder between the outer section and the inner section, the shoulder having a dimension greater than the outer dimension of the inner section; and
plural wiring conduits, each wiring conduit having one end thereof connected to a respective electrical conductor pad in the outer section and a free end extending from the inner section; and
fastening means for connecting the main body to a wall.

15. The female electrical receptacle according to claim 14 wherein the outer section defines a first dimension, and the inner section defines a second dimension that is smaller than the fist dimension and the shoulder is defined between the outer section and the inner section.

16. The female electrical receptacle according to claim 14 wherein the shoulder is defined by a flange between the outer section and the inner section.

17. The female electrical receptacle according to claim 14 wherein the fastening means comprises threads on the inner section and a threaded nut configured for threading onto the inner section.

18. A female electrical receptacle comprising:
a one piece main body defined by an outer section having an outer dimension with an outer end portion configured for receiving a male electrical plug, and an inner section having an outer dimension, wherein the outer dimension of the inner section is smaller than the outer dimension of the outer section to define a shoulder between the outer section and the inner section: and
a fastener for connecting the main body to a wall such that the shoulder abuts the wall and the inner section extends through an opening formed in said wall.

19. The female electrical receptacle according to claim 18 further comprising plural wiring conduits, each connected to an electrical conductor pad in the outer section and each having a free end extending from the inner section.

20. The female electrical receptacle according to claim 19 wherein the fastener further comprises a threaded inner section and a threaded nut configured for engaging the threaded inner section.
